(19) United States
(12) Patent Application Publication
(10) Pub. No.: US 2005/0082697 A1
(43) Pub. Date: Apr. 21, 2005

(54) Solvent-resisting holographic film and manufacture thereof

(75) Inventors: Tsung-Ming Shiao, Hsinchu (TW); Ming-Sing Lai, Hsinchu (TW)

Correspondence Address: BRUCE H. TROXELL, SUITE 1404, 5205 LEESBURG PIKE, FALLS CHURCH, VA, 22041, US

(73) Assignee: KLASER TECHNOLOGY INC.

(21) Appl. No.: 10/684,677

(22) Filed: Oct. 15, 2003

(51) Int. Cl. B29D 11/00; G03H 1/00; B42D 15/00

(52) U.S. Cl. 264/1.31; 430/1; 430/2; 359/2; 283/86; 264/1.27

(57) ABSTRACT

A solvent-resisting holographic film is a plastic film combined with an UV resin film, the UV resin film has a holographic pattern thereon, the outer surface of the holographic pattern is combined with a evaporation plating layer with a high refractive index material, each of another sides of said plastic film and said evaporation plating layer is combined with a well chemical-resisting UV resin film. The present invention can save production cost and attains a faster speed in manufacturing a holographic film. And, the film is well resistant to every king of solvent and capable of solving the problems of the bad solvent resistance of a general holographic film product at present causing the holographic pattern thereof to disappear easily.

### BACKGROUND OF THE INVENTION

1. Field of the Invention

The present invention relates to a holographic film and manufacture thereof, more particularly to a laser holographic pattern film that is well resistant to solvents such as Toluene, Acetone and MEK and is applicable to highly added value products such as spray paint or paint coating, cosmetic laser gold powder and toy decoration.

2. Description of Related Art

At present, the manufacturing method of the holographic laser pattern film product made from a plastic substrate film such as PET, OPP or PVC is almost to spread a layer of low softening temperature (approximately 80° C.-200° C.) resin coating on the surface of a substrate film, then to paste and print the film through a master metal plate with a holographic laser decoration pattern to duplicate the lines of the laser holographic pattern on the master metal plate onto the surface of the film at certain heating and pressing conditions by a embossing way to finish a hologram film with a laser holographic pattern. The hologram film can be used broadly on the decoration and anti-counterfeit of goods to increase the added values thereof.

U.S. Pat. No. 6,432,245 discloses a method for manufacturing a metal film with a projecting pattern. The method comprises the following steps: spreading a layer of transparent thermosetting resin on a master tape with a projecting pattern, heat-drying the resin, sintering a layer of polyvinyl alcohol after the projecting pattern is duplicated, peeling off the resin layer from the master tape, combining a metal film with one side of the resin lay where the laser holographic pattern is duplicated and disposing of the polyvinyl alcohol to allow the metal film to have a projecting pattern.

However, the above-mentioned manufacturing of a resin coating layer with a laser holographic pattern lines by means of an embossing or heating way needs to use heating and/or pressing facilities, this leads to a higher production cost and longer heating time period, the latter makes the manufacturing speed lower. Furthermore, the softening temperature of the resin-coating layer is low and the chemical tolerance thereof is bad. The resin-coating layer is eroded and dissolved so that the laser holographic pattern disappears when this laser holographic pattern film is placed at an operation environment in where a solvent such as Toluene, Acetone or MEK is disposed. Therefore, the film so made is unable to provide the application for a product with highly added value such as spray paint or paint coating, cosmetic laser gold powder and toy decoration.

### SUMMARY OF THE INVENTION

The main object of the present invention is to provide a solvent-resistant holographic film, being well resistant to every king of solvent and being capable of solving the problems of the bad solvent resistance of a general holographic film product at present causing the holographic pattern thereof to disappear easily.

Another object of the present invention is to provide a manufacturing method for a solvent-resistant holographic film, being able to save production cost and to attain a faster speed in manufacturing a holographic film. Thereby, the holographic film is applicable to highly added value products such as spray paint or paint coating, cosmetic laser gold powder and toy decoration.

### BRIEF DESCRIPTION OF THE DRAWINGS

The present invention can be more fully understood by reference to the following description and accompanying drawings, in which:

FIG. 1A to 1E are schematic views of a manufacturing process of a first embodiment according to the present invention; and

FIG. 2A to 2C are schematic views of a part of a manufacturing process of a second embodiment according to the present invention.

### DETAILED DESCRIPTION OF THE PREFERRED EMBODIMENTS

The present invention mainly uses UV resin and an UV lamp to manufacture a solvent-resisting holographic film so as to increase a manufacturing speed and save a production cost and provides a structure of a holographic film that is highly resistant to every kind of solvent; it can solve the problem of the disappearance of the holographic pattern caused from poor solvent-resisting property of a general holographic film product at present.

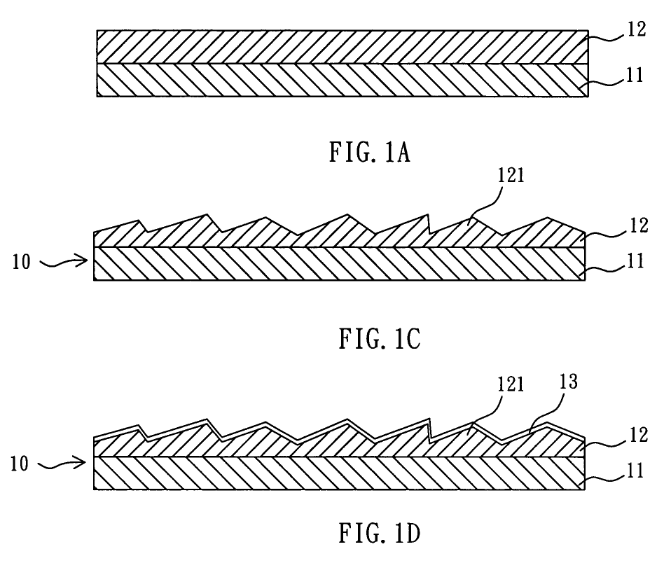

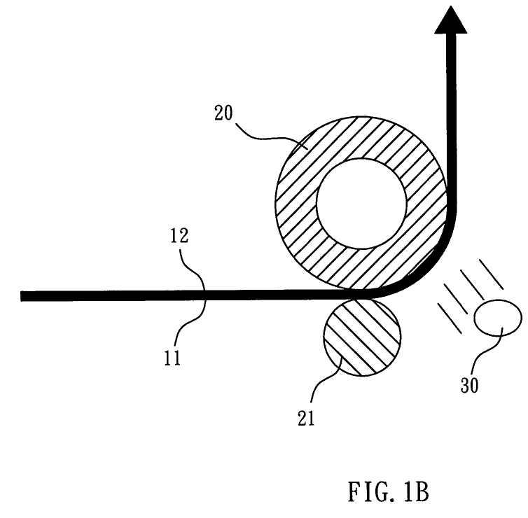

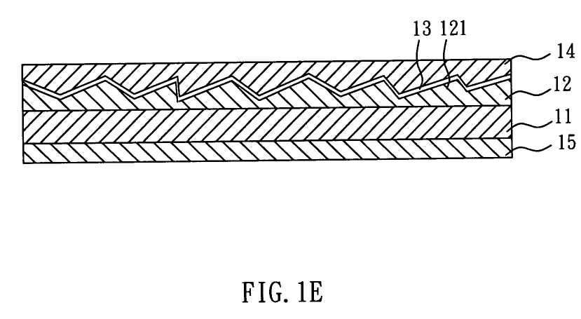

Please refer to FIG. 1A to 1E. A manufacturing method of the first embodiment according to the present invention comprises the following steps: (1) spread a layer of UV resin film 12 with a uniform thickness approximately 1 to 10 μm onto the upper surface of a plastic film 11 by means of off-set printing or gravure printing, as FIG. 1A shows. The plastic film 11 is chosen from a plastic material such as PET, OPP, PVC or PC. The better material of the UV resin film 12 is a special UV resin with highly heat-resisting and stiff properties such as Resin KLASER-KV03 made from the patent applicant of the present invention.

(2) stick the UV resin film 12 with a metal wheel 20 engraved with a holographic pattern, and use a press wheel 21 to press another side of the plastic film 11 toward the metal wheel 20, as FIG. 1B shows, to cause the UV resin film 12 and the holographic pattern to stick each other together closely. Then, use an UV lamp 30 to illuminate the UV resin film 12 stuck closely with the metal wheel 20 to cause the UV resin 12 to harden instantly. The UV resin film 12 is combined closely with the plastic film 11 after the illumination of the UV lamp 30 due to the good adhesion between the UV resin film 12 and the chosen plastic film 11. Therefore, the holographic pattern is duplicated onto the UV resin film 12 to allow the plastic film 11 to become a semifinsihed holographic film 10 with a holographic pattern 121, as FIG. 1C shows. (3) process evaporation plating on the semifinished holographic film 10 with the holographic pattern 121 with a high refractive index material such as Al, ZnS or TiO₂ to the outside surface of the holographic pattern 121 to be combined with a evaporation plating layer 13 so as to fix and protect the holographic pattern 121, as FIG. 1D shows. (4) spread respectively layers of UV resin films 14 and 15 with a uniform thickness approximately 3 to 5 μm on the two sides of the semifinished holographic film 10 by means of off-set printing or gravure printing, as FIG. 1E shows. The better material of the UV film 14 and 15 is chemical-resisting UV resin such as Resin KLASER-KV03 made from the patent applicant of the present invention. Then, use the UV lamp to illuminate sufficiently to harden the UV resins 14 and 15 instantly to become holographic films.

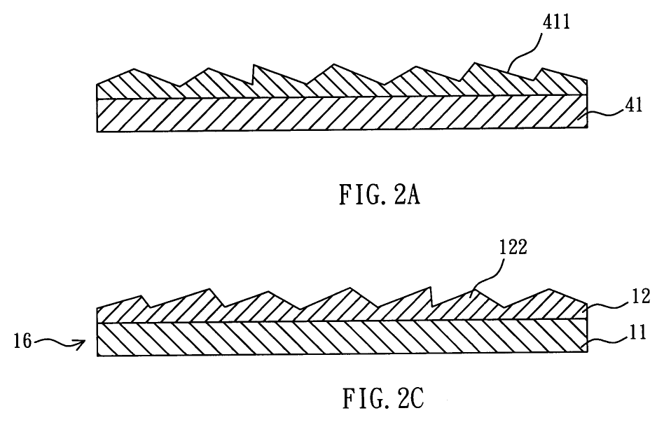

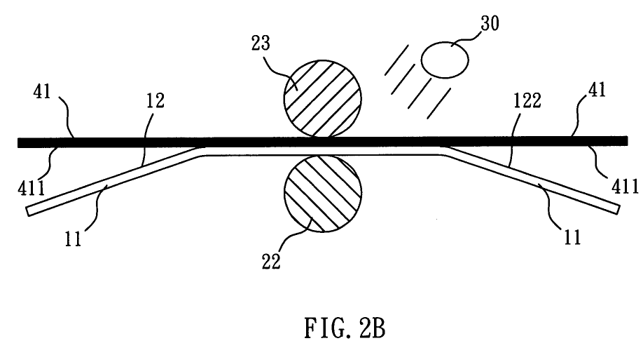

Please refer to FIG. 2A to 2C. The figures show a manufacturing method of the second preferred embodiment according to the present invention. The method is a method that changes the step (2) of the first preferred embodiment shown above to become the following step: (2B) stick the UV resin film 12 to a master film 41 with a holographic pattern 411, as FIG. 2A shows, and use two press wheels 22 and 23 to press them inward respectively from the outsides of the master film 41 and the plastic film 11 to cause the UV resin films 12 and the holographic pattern 411 to stick closely together. Then, use the UV lamp 30 to illuminate sufficiently on one side of the master film 41 to cause the UV resin film 12 to harden instantly. Thereafter, the holographic pattern 411 on the master film 41 is duplicated onto the UV resin film 12, and the UV resin film 12 and the plastic film 11 are combined together fixedly. Separate the master 41 and the plastic film 11, as FIG. 2B shows, to cause the plastic film 11 to become a semifinished holographic film 16 with a holographic pattern 122, as FIG. 2C shows. The master film 41 with the holographic pattern 411 can then be used repeatedly.

The holographic film made from the methods mentioned above is highly resistant to every kind of solvent due to the two sides thereof are all covered with the UV resin layers with extremely excellent chemical-resisting and heat-resisting properties; it can solve the problem of the disappearance of the holographic pattern caused from poor solvent-resisting property of a general holographic film product at present and is applicable to highly added value products such as spray paint or paint coating, cosmetic laser gold powder and toy decoration to allow the hologram film to be used in a broad range.

The UV resin and the UV lamp used in the present invention are all popularly used in the industry. Heating and/or pressing facilities are/is unnecessary and so is waiting for heating. A mass production can be practiced so that a large amount of production cost can be saved. Therefore, the solvent-resisting holographic film has a lower price to be more competitive in the market.

It is noted that the solvent-resisting holographic film and the manufacture thereof described above is the preferred embodiment of the present invention for the purpose of illustration only, and are not intended as a definition of the limits and scope of the invention disclosed. Any modifications and variations that may be apparent to a person skilled in the art are intended to be included within the scope of the present invention.

1. A manufacturing method for a solvent resisting holographic film, comprising the following steps:
(1) spreading an UV resin film on a plastic film;
(2) sticking said UV resin with a metal wheel engraved with a holographic pattern; using a UV lamp to illuminate said UV resin film stuck closely with said metal wheel to cause said UV resin film to harden and to stick closely with said plastic film; and then, separating said UV resin film from said metal wheel; whereby, said holographic pattern on said metal wheel being duplicated onto said UV resin film so as to cause said plastic film to become a semifinished holographic film with a holographic pattern;
(3) combining the outside surface of said holographic pattern of said semifinished holographic film with a evaporation plating layer with a high refractive index material; and
(4) spreading a layer of well chemical-resisting U resin film respectively to each of two sides of said semifinished holographic film, then using said UV lamp to illuminate again to harden said well chemical-resisting UV resin film instantly; whereby, said semifinished holographic film is caused to become a solvent-resisting holographic film.

2. A manufacturing method for a solvent resisting holographic film, comprising the following steps:
(1) spreading an UV resin film on a plastic film;
(2) sticking said UV resin with a mater film with a holographic pattern to cause said UV resin film to stick closely with said holographic pattern; and then, using an UV lamp to illuminate to harden said UV resin film to stick with said plastic film closely; and then, separating said UV resin film from said master film; whereby, said holographic pattern being duplicated onto said UV resin film so as to cause said plastic film to become a semifinished holographic film with a holographic pattern;
(3) combining the outside surface of said holographic pattern of said semifinished holographic film with a evaporation plating layer with a high refractive index material; and
(4) spreading a layer of well chemical-resisting U resin film respectively to each of two sides of said semifinished holographic film, then using said UV lamp to illuminate again to harden said well chemical-resisting UV resin film instantly; whereby, said semifinished holographic film is caused to become a solvent-resisting holographic film.

3. The method according to claim 1, wherein said plastic film is pressed by a press wheel toward said metal wheel, whereby, said UV resin film is stuck with said metal wheel closely.

4. The method according to claim 1, wherein said high refractive index material is chosen from one of Al, ZnS and TiO₂.

5. The method according to claim 2, wherein said high refractive index material is chosen from one of Al, ZnS and TiO₂.

6. The method according to claim 2, wherein each of the outer sides of said master film and said plastic film is pressed respectively inward by a press wheel, whereby, said UV resin film is stuck with said master film closely together.

7. A solvent-resisting holographic film, comprising a plastic film combined with an UV resin film, said UV resin film having a holographic pattern thereon, the outer surface of said holographic pattern being combined with a evaporation plating layer with a high refractive index material, each of another sides of said plastic film and said evaporation plating layer being combined with a well chemical-resisting UV resin film.

8. The film according to claim 7, wherein said high refractive index material is chosen from one of Al, ZnS and TiO₂.
